(19) United States
(12) Patent Application Publication
(10) Pub. No.: US 2026/0342190 A1
(43) Pub. Date: Oct. 29, 2026

(54) RESOLVER

(71) Applicant: DR. JOHANNES HEIDENHAIN GmbH, Traunreut (DE)

(72) Inventors: Thomas SCHRÖDER, Höhenkirchen-Seigertsbrunn (DE); Gerhard PIELOK, München (DE); Nicolai WANGLER, Grassau (DE)

(21) Appl. No.: 19/651,943

(22) Filed: Apr. 20, 2026

(30) Foreign Application Priority Data
Apr. 24, 2025 (DE) 102025001367.1

(51) Int. Cl. H02K 24/00; H02K 11/225

(52) U.S. Cl. CPC H02K 24/00; H02K 11/225

(57) ABSTRACT

A resolver includes a first assembly and a second assembly that are rotatable relative to each other about an axis. The first assembly includes a first winding arranged in a first housing. The first housing includes a first housing shell and a second housing shell, in which the first housing shell has first tabs and the second housing shell has second tabs. The first and second tabs extend with an axial directional component and are joined together in an interlocking manner, offset relative to each other in the circumferential direction. The first housing shell has a first web, which is arranged radially offset to the first tabs of the first housing shell and extends with a parallel directional component to the first tabs of the first housing shell.

### CROSS-REFERENCE TO RELATED APPLICATIONS

The present application claims priority to Application No. 10 2025 001 367.1, filed in the German Patent and Trademark Office (Deutsche Patent- und Markenamt (DPMA)) on Apr. 24, 2025, which is expressly incorporated herein in its entirety by reference thereto.

### FIELD OF THE APPLICATION

The present application relates to a resolver, e.g., a brushless resolver.

### BACKGROUND INFORMATION

In electrical engineering, a resolver is an electromagnetic transducer for converting the angular position of a rotor into an electrical variable or electrical signals. These signals are ultimately used to determine the relative angular position between two components that are rotatable in relation to each other, for example, two machine parts that are rotatable in relation to each other. In the present application, the term resolver also includes transducers referred to as synchro or rotary position transmitters.

A resolver often has offset stator windings, arranged in a housing, that enclose a rotor with rotor windings located inside the housing. In this arrangement, both the stator windings and the rotor windings are arranged on respective laminated cores, which serve to guide the magnetic flux. The laminated cores consist of a plurality of individual laminations, which are usually made of a soft magnetic material to increase their electromagnetic effect.

In brushless resolvers, a supply voltage is transmitted contactlessly through a stationary winding of a transformer to a rotating winding of the transformer. Typically, the stator and rotor windings are arranged in respective transformer housings.

Such resolvers are usually produced in large quantities, so that simple, automated production is required.

German Patent Document No. 10 2009 020 327 describes a brushless resolver, in which a housing for the windings of the transformer consists of two housing shells with interlocking tabs.

### SUMMARY

Example embodiments of a resolve, as described herein, have an extremely high measuring accuracy and can also be manufactured with minimal effort.

According to example embodiments, a resolver includes a first assembly and a second assembly that are rotatable relative to each other about an axis. The resolver is used and adapted, e.g., specifically designed or constructed, to determine the relative angular position between the two assemblies. The first assembly includes a first winding arranged in a first housing, and the second assembly includes a second winding arranged in a second housing. The first housing has a first housing shell and a second housing shell, the first housing shell has first tabs, and the second housing shell has second tabs. The first tabs and/or the second tabs extend with an axial directional component, i.e., with a directional component parallel to the axis. Furthermore, the first tabs and the second tabs are joined together in an interlocking manner with axial overlap, offset relative to each other in the circumferential direction. The first housing shell has a first web, which is arranged radially offset to the first tabs and extends with a parallel directional component to the first tabs of the first housing shell and/or to the second tabs of the second housing shell.

The terms radial and axial refer to the axis about which the assemblies are rotatable relative to each other. Thus, axial means parallel to the axis and radial means orthogonal to the axis.

For example, the second housing shell has a second web, which is arranged radially offset to the second tabs of the second housing shell and extends with a parallel directional component to the second tabs of the second housing shell and/or to the first tabs of the first housing shell.

According to example embodiments, the first housing shell, the second housing shell, or both housing shells are produced from a metal sheet whose material includes nickel and iron.

For example, the metal sheet has a thickness of less than 0.75 mm, e.g., less than 0.6 mm, less than 0.5 mm, etc.

For example, the first housing shell is arranged, such that an end face of a first tab is opposite a respective second section of the second housing shell. Furthermore, an end face of the second tabs may be arranged opposite a respective first section of the first housing shell.

According to example embodiments, the second section of the second housing shell is arranged with a radial overhang or flush relative to one of the first tabs of the first housing shell. Similarly, the first section of the first housing shell may be arranged with a radial overhang or flush relative to one of the second tabs of the second housing shell.

For example, the first web, the second web, or both webs extend in the circumferential direction over an angle of at least 90°, e.g., at least 120°, at least 270°, etc. For example, the first web, the second web, or both extend in the circumferential direction over an angle of 360°, i.e., over the entire circumference.

According to example embodiments, the first web extends in the same direction as the second web. This means, for example, that the free ends of the webs point in the same direction.

For example, the first web and the second web each have an equal distance from the axis. For example, the webs are located on the jacket surface of a virtual circular cylinder whose axis of symmetry coincides with the axis about which the assemblies are rotatable relative to each other.

For example, the first web, the second web, or both are arranged at a radial distance opposite the second winding and/or the second housing. One of the webs or both webs are thus arranged opposite the second winding or the second housing, so that there is a gap in the radial direction between the web and the second winding or between the web and the second housing.

According to example embodiments, the first housing is arranged radially outside the second housing, or the first housing encloses the second housing.

The arrangement of the resolver described herein allows for achieving high measuring accuracy while at the same time reducing the amount of material required.

According to example embodiments, the resolver is arranged as a brushless resolver, and the winding is assigned to a transformer.

The housing shells may be formed in one piece from a metal sheet. Furthermore, the housing shells may be produced by a punching process and a bending process.

The housing shells may be rotationally symmetrical with respect to the axis.

Further features and aspects of example embodiments of the present application are described in more detail below with reference to the appended schematic Figures.

### BRIEF DESCRIPTION OF THE DRAWINGS

FIG. 1 is a longitudinal cross-sectional view of a resolver.

FIG. 2 is a top view of a first housing shell.

FIG. 3 is a perspective view of the first housing shell.

FIG. 4 is a perspective view of a second housing shell.

FIG. 5 is a perspective view of a first housing.

FIG. 6 is an enlarged cross-sectional view of the first housing.

### DETAILED DESCRIPTION

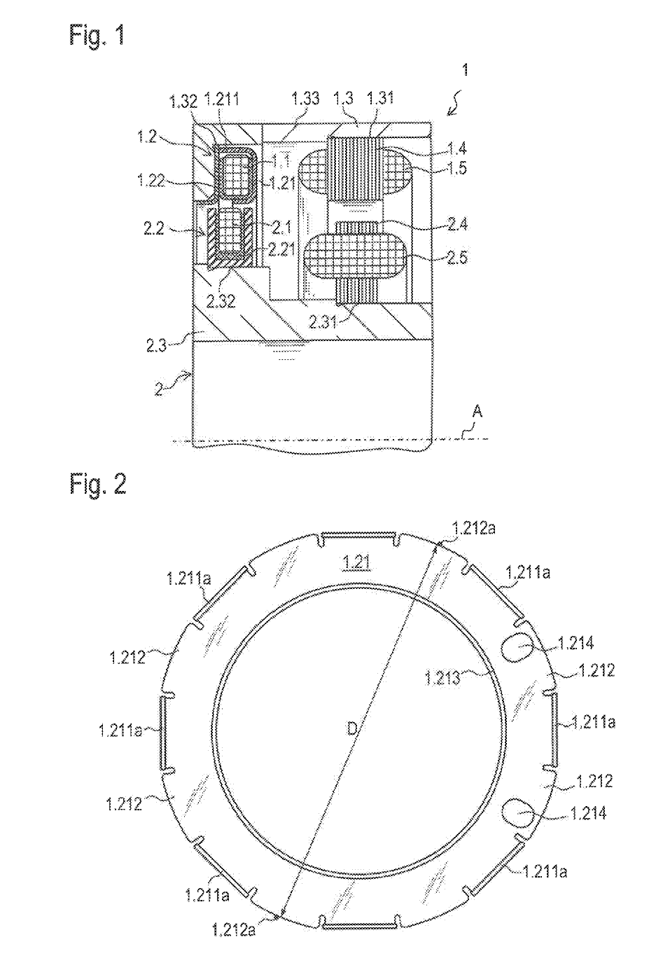

As illustrated in FIG. 1, the resolver includes two assemblies 1, 2 that are rotatable relative to each other about an axis A. For example, the first assembly 1 may be arranged as a stator, and the second assembly 2 may be arranged as a rotor. The first assembly 1 has a resolver housing 1.3 with a region that serves as a holder 1.31 for a laminated core 1.4. Receiver windings 1.5 are arranged on the laminated core 1.4. For example, two receiver windings 1.5 offset by 90° are provided.

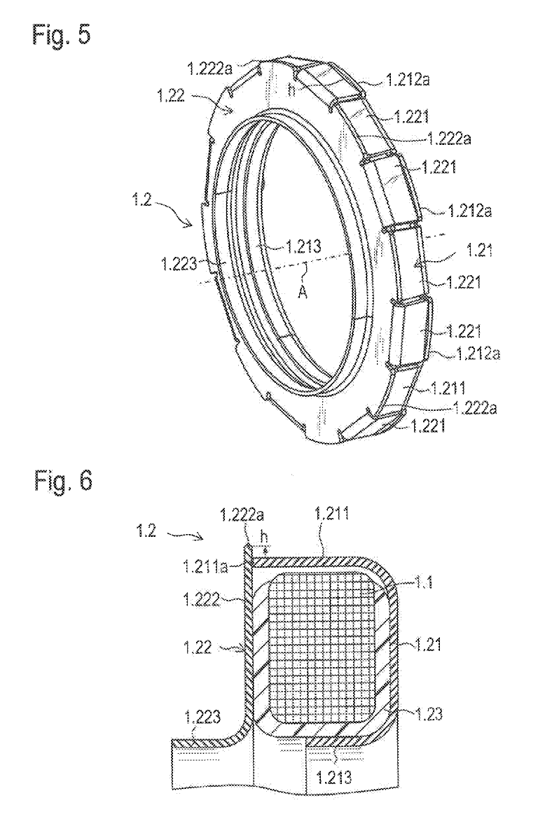

Furthermore, the first assembly has a holding region 1.32 for receiving a transformer part that includes, or consists of, windings 1.1 and a first housing 1.2 surrounding the windings 1.1. The first housing 1.2 includes a first housing shell 1.21 and a second housing shell 1.22. A dielectric support body 1.23 is arranged between the windings 1.1 and the housing shells 1.21, 1.22 (see, e.g., FIG. 6). The housing shells 1.21, 1.22 each have tabs 1.211, 1.221, which are oriented with an axial directional component and are joined together in an interlocking manner with axial overlap, offset relative to each other in the circumferential direction (see also, e.g., FIG. 5).

As illustrated in FIG. 1, the second assembly 2 has a shaft 2.3 on which a holding region 2.32 is arranged, which serves for receiving a rotor-side transformer part that includes windings 2.1 and a second housing 2.2 surrounding the windings 2.1. The second housing 2.2 also includes a support body 2.21 made of dielectric material, which receives the second windings 2.1. A laminated core 2.4 with transmission windings 2.5 is arranged on a holder 2.31 of the shaft 2.3. For example, the transmission windings 2.5 together with the laminated core 2.4 are cast with a casting compound after assembly of the second assembly 2.

In the illustrated example embodiment, the shaft 2.3 is arranged as a hollow shaft in which a motor shaft, whose angular position is to be determined, can be fixed in a rotationally fixed manner.

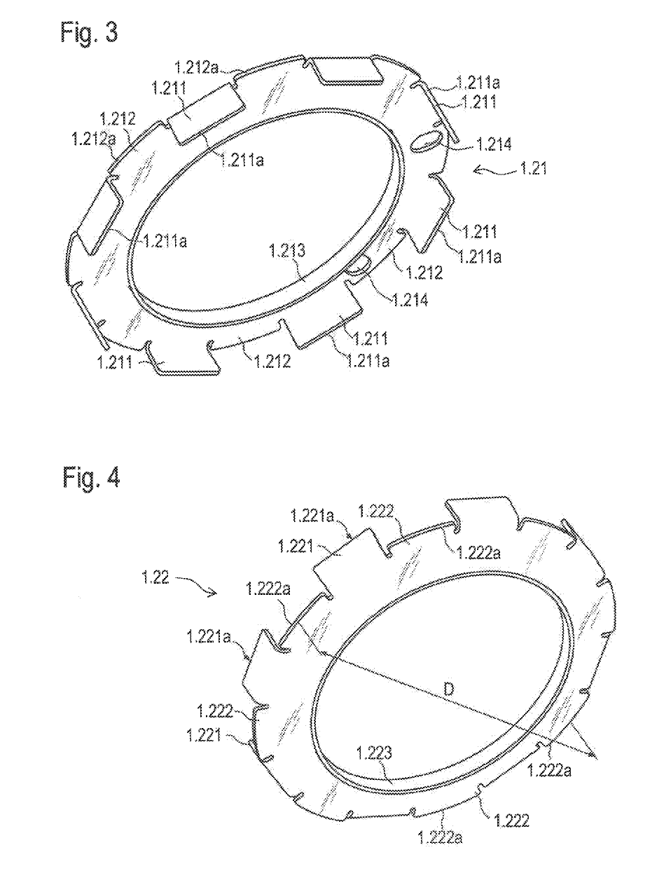

FIG. 2 is a top view, and FIG. 3 is a perspective view, of the first housing shell 1.21. The first housing shell 1.21 includes first tabs 1.211 (see, e.g., FIG. 3), first sections 1.212, and a first web 1.213. The first housing shell 1.21 is produced from a flat sheet metal part, from which a one-piece punched part is first cut out. This punched part is formed by a bending process so that the first tabs 1.211 and the first web 1.213 are present, while the first sections 1.212 are not deformed. The first tabs 1.211 have end faces 1.211a or surfaces produced by the punching process. Similarly, the first sections 1.212 have end faces 1.212a or surfaces produced by the punching process. The end faces 1.212a of the first sections 1.212 are arranged at a distance D from diametrically opposed ends 1.212a. The first web 1.213 is arranged radially inwardly offset to the first tabs 1.211 and extends with a parallel directional component to the first tabs 1.211, e.g., in the axial direction. In addition, the first housing shell 1.21 includes holes 1.214, which are provided for feeding through stranded wires.

FIG. 4 is a perspective view of the second housing shell 1.22. The second housing shell 1.22 is also produced using a punching and bending process. The second housing shell 1.22 includes second tabs 1.221, second sections 1.222, and a second web 1.223. The second tabs 1.221 have end faces 1.221a or surfaces produced by the punching process. The end faces 1.222a or surfaces of the second sections 1.222 are also produced by the punching process. The end faces 1.222a of the second sections 1.222 are arranged diametrically at a distance D from opposed ends 1.222a. The second web 1.223 is arranged radially inwardly offset to the second tabs 1.221 and extends with a parallel directional component to the second tabs 1.221, e.g., in the axial direction.

Both housing shells 1.21, 1.22 are produced from a metal sheet only 0.35 mm thick, the material of which includes nickel and iron or includes silicon and iron. These materials have a comparatively high magnetic permeability.

The two housing shells 1.21, 1.22 are assembled as illustrated in FIG. 5 to form the first housing 1.2 such that the tabs 1.211, 1.221, which are oriented with an axial directional component, are joined together in an interlocking manner, offset relative to each other in the circumferential direction.

The first housing 1.2 can be installed in the resolver housing 1.3. As a result of the punching process, the end faces 1.212a, 1.222a of the first and second sections 1.212, 1.222 (and at these points without a forming process) have a comparatively exact distance D (see, e.g., FIGS. 2 and 4) with small dimensional tolerances. For example, the first sections 1.212 belonging to the first housing shell 1.21 are arranged with radial overhang h (see, e.g., FIGS. 5 and 6) relative to the second tabs 1.221 of the second housing shell 1.22. Similarly, the second sections 1.222 belonging to the second housing shell 1.22 are arranged with radial overhang h relative to the first tabs 1.211 of the first housing shell 1.21 (with h ≥ 0).

As a result, the end faces 1.212a, 1.222a or surfaces of the sections 1.212, 1.222 can be used to center the first housing 1.2 in the resolver housing 1.3.

The second housing 2.2 is mounted on the shaft 2.3 such that the rotor-side winding 2.1 is arranged radially opposite the stator-side winding 1.1 (see, e.g., FIG. 1). For example, the first web 1.213 and the second web 1.223 are arranged at a radial distance opposite the second winding 2.1 or at a radial distance opposite the second housing 2.2.

The relative angular position between the first assembly 1 and the second assembly 2 can be determined using a corresponding resolver. For this purpose, a sinusoidal alternating current is applied to the windings 1.1 of the first assembly 1, which results in an alternating voltage with a specified transformation ratio being induced in the windings 2.1 of the second assembly 2. This alternating voltage is thus also applied to the transmitter windings 2.5 of the second assembly 2, so that corresponding output voltages are induced in the receiver windings 1.5, of the first assembly 1, which enclose the transmitter windings 2.5 of the second assembly 2. If two 90° offset receiver windings 1.5 of the first assembly 1 are used, two 90° phase-shifted voltage signals can be tapped, which depend on the relative angular position between the first assembly 1 and the second assembly 2. The present resolver is thus arranged as a brush-less or slip-ring-less resolver.

As illustrated, for example, in FIG. 6, the end faces 1.211a of the first tabs 1.211 belonging to the first housing shell 1.21 are opposite a respective second section 1.222 of the second housing shell 1.222. For example, each of the ends 1.211a of the first tabs 1.211 can contact a respective second section 1.222 of the second housing shell 1.22. Similarly, at another point (offset in the circumferential direction), the end faces 1.221a of the second tabs 1.221 of the second housing shell 1.22 are opposite a respective first section 1.212 of the first housing shell 1.21. Here, too, the ends 1.221a of the second tabs 1.221 can contact a respective first section 1.212 of the first housing shell 1.21. As a result, the magnetic field emerging at the end faces 1.211a, 1.221a of the tabs 1.211, 1.221 is conducted directly into the opposite second housing shell 1.22. Accordingly, this arrangement minimizes dispersion losses. The material selection described above for the metal sheets of the two housing shells 1.21, 1.22 allows the use of extremely thin metal sheet thicknesses, so that the resolver can be produced with good electromagnetic properties using relatively little material.

In the illustrated example embodiment, the first web 1.213 extends in the same direction as the second web 1.223, which means that the ends of the webs 1.213, 1.223 point in the same direction (in FIG. 6 to the left, for example) or that the curve of the webs 1.213, 1.223 is not antiparallel.

Due to the arrangement of the webs 1.213, 1.223 relative to the second housing 2.2 or to the second winding 2.1, the resolver is comparatively insensitive to axial displacements between the first assembly 1 and the second assembly 2. This is because the webs 1.213, 1.223 extending in the axial direction cause the webs 1.213, 1.223 to be opposite the second housing 2.2 or the second winding 2.1 over a comparatively large axial displacement. As a result, the transformation ratio remains high over a large axial displacement. In addition, the webs 1.213, 1.223 also have the advantage that they make the housing shells 1.21, 1.22 mechanically rigid or stable despite their thin wall thicknesses.

What is claimed is:

1. A resolver, comprising:
a first assembly including a first winding arranged in a first housing, the first housing including a first housing shell, including first tabs and a first web arranged radially offset to the first tabs and extending with a parallel directional component to the first tabs, and a second housing shell, including second tabs, the first tabs and the second tabs extend with an axial directional component and are joined together in an interlocking manner, offset relative to each other in a circumferential direction; and
a second assembly including a second winding arranged in a second housing;
wherein the first assembly and the second assembly are rotatable relative to each other about an axis, and the resolver is adapted to determine a relative angular position between the first assembly and the second assembly.

2. The resolver according to claim 1, wherein the second housing shell includes a second web arranged radially offset to the second tabs and extending with a parallel directional component to the second tabs.

3. The resolver according to claim 1, wherein the first housing shell and/or the second housing shell is formed of a metal sheet, a material of the metal sheet including nickel and iron.

4. The resolver according to claim 1, wherein the first housing shell and/or the second housing shell is formed of a metal sheet, a material of the metal sheet including silicon and iron.

5. The resolver according claim 1, wherein the first housing shell and/or the second housing shell is formed of a metal sheet having a thickness of less than 0.75 mm.

6. The resolver according to claim 1, wherein an end face of each first tab is arranged opposite a respective second section of the second housing shell.

7. The resolver according to claim 1, wherein an end face of each second tab is arranged opposite a respective first section of the first housing shell.

8. The resolver according to claim 6, wherein an end face of each second tab is arranged opposite a respective first section of the first housing shell.

9. The resolver according to claim 6, wherein each second section of the second housing shell is arranged with a radial overhang or flush relative to a respective one of the first tabs of the first housing shell.

10. The resolver according to claim 7, wherein each first section of the first housing shell is arranged with a radial overhang or flush relative to a respective one of the second tabs of the second housing shell.

11. The resolver according to claim 8, wherein each second section of the second housing shell is arranged with a radial overhang or flush relative to a respective one of the first tabs of the first housing shell, and wherein each first section of the first housing shell is arranged with a radial overhang or flush relative to a respective one of the second tabs of the second housing shell.

12. The resolver according to claim 1, wherein the first web extends in the circumferential direction over an angle of at least 90°.

13. The resolver according to claim 2, wherein the first web and/or the second web extends in the circumferential direction over an angle of at least 90°.

14. The resolver according to claim 1, wherein the first web extends in the circumferential direction over an angle of 360°.

15. The resolver according to claim 2, wherein the first web and/or the second web extends in the circumferential direction over an angle of 360°.

16. The resolver according to claim 2, wherein the first web extends in the same direction as the second web.

17. The resolver according to claim 2, wherein the first web and the second web are located at an equal distance from the axis.

18. The resolver according to claim 1, wherein the first web and/or the second web is arranged at a radial distance opposite the second winding and/or the second housing.

19. The resolver according to claim 1, wherein the first housing is arranged radially outside the second housing.

20. The resolver according to claim 8, wherein the first housing shell includes a plurality of diametrically opposite first sections, and the second housing shell includes a plurality of diametrically opposite second sections.
